(19) United States
(12) Patent Application Publication
(10) Pub. No.: US 2026/0170795 A1
(43) Pub. Date: Jun. 18, 2026

(54) SYSTEMS AND METHODS OF USING ARTIFICIAL INTELLIGENCE TO UNDERSTAND VIDEO CONTENT

(71) Applicant: Cynapse Pte. Ltd., Singapore (SG)

(72) Inventors: Guy Ron, Singapore (SG); Noam Berda, Singapore (SG); Prabodh Tripathi, Singapore (SG); Hizkia Felix, Singapore (SG); Nitin Gururaj Kallur, Singapore (SG)

(21) Appl. No.: 19/039,719

(22) Filed: Jan. 28, 2025

Related U.S. Application Data
(63) Continuation-in-part of application No. 18/981,227, filed on Dec. 13, 2024.

(51) Int. Cl. G06V 10/70; G06F 40/226

(52) U.S. Cl. CPC G06V 10/70; G06F 40/226

(57) ABSTRACT

An alert generating systems and methods that receive user queries and processes those user queries in view of video content to generate alerts based on the video content. Alert generating systems and methods leverage VLLMs and other artificial intelligence models to both generate frame documents that feature information about objects, interactions, and contextual information about scenes from video content and to generate alerts based on a user's query that asks about those scenes. Embodiments involve query parsing, rule-based reasoning checking, VLLM reasoning checking, and alert generation based thereon.

This application claims priority to and is a continuation-in-part of U.S. patent application No. 18/981227, filed Dec. 13, 2024. All extrinsic materials identified in this application are incorporated by reference in their entirety.

### FIELD OF THE INVENTION

The field of the invention is using VLM and VLLMs to generate comprehensive and contextualized understandings of video content.

### BACKGROUND

The background description includes information that may be useful in understanding the present invention. It is not an admission that any of the information provided in this application is prior art or relevant to the presently claimed invention, or that any publication specifically or implicitly referenced is prior art.

Scene understanding has traditionally been achieved through the use of machine learning and computer vision models, including detectors, classifiers, and segmentation models. These models analyze visual data to recognize the presence, location, and boundaries of specific objects. Traditional scene understanding tools, which include detectors, classifiers, and segmentation models, have limitations such as needing fine-tuning for specific use cases, providing only object-level understanding, lacking general context of the scene, and not inherently understanding object-object interactions.

Although existing technologies can nevertheless be useful for things like object search based on object attributes, generating alerts based on object attributes, and triggering alerts based on object-object interactions, traditional scene understanding tools are limited in their inability to perform comprehensive scene analysis and provide a detailed breakdown of the objects in the scene.

With the advent of Large Language Models (LLMs) and Open Vocabulary Vision Language Model (sometimes referred to as Vision Language models, or VLMs), scene understanding can improved by prompting VLLMs with both images and text. But these models lack capabilities in localizing objects as well as identifying object-object relationships. Moreover, VLLMs require immense processing power. Thus, there exists a need in the art for improved scene understanding that leverages large language models to carry out object detection, object attribute classification, and to determine object-object interactions to create detailed descriptions and searchable text for video-based events that can operate in real time on live video without any VLLM-based slowdown.

### SUMMARY OF THE INVENTION

The present invention provides apparatus, systems, and methods directed to video interpretation using VLLMs. In one aspect of the inventive subject matter, an alert generating system includes: a user interface configured to receive a user query about a scene; a query module comprising a guardrail module and a query parsing module, where the query module is configured to receive the user query from the user interface and to use the query parsing module and the guardrail module to validate the user query to generate a validated user query; a scene understanding module configured to process the scene to generate a frame document that comprises information about an object in the scene; a reasoning engine configured to carry out a rule-based check and a VLLM reasoning check based on the validated user query and the frame document; the reasoning engine configured to use at least one of rule-based reasoning and VLLM reasoning to generate an alert based on the validated user query and the frame document; and the reasoning engine further configured to transmit an alert packet to a computing device, where the alert packet causes the computing device to generate a visual notification of the alert.

In some embodiments, the query parsing module is configured to determine a set of models that are necessary to process the user query. The guardrail module can be configured to filter prohibited user queries, where prohibited user queries can be filtered based on a prohibited word or a prohibited context. In some embodiments, the query parsing module is further configured to select a set of models for the scene understanding module to use to generate the frame document.

In another aspect of the inventive subject matter, an alert generating system features: a user interface configured to receive a user query about a scene; a query module comprising a query parsing module, where the query module is configured to receive the user query from the user interface and to use the query parsing module to validate the user query to generate a validated user query; a scene understanding module configured to process the scene to generate a frame document that comprises information about an object in the scene; a reasoning engine configured to carry out a rule-based check and a VLLM reasoning check based on the validated user query and the frame document; the reasoning engine configured to use at least one of rule-based reasoning and VLLM reasoning to generate an alert based on the validated user query and the frame document; and the reasoning engine further configured to transmit an alert packet to a computing device, where the alert packet causes the computing device to generate a visual notification of the alert.

In some embodiments, the query module further comprises a guardrail module, where the guardrail module can be configured to filter prohibited user queries. Prohibited user queries can be filtered based on a prohibited word or a prohibited context. In some embodiments, the query parsing module is configured to determine a set of models that are necessary to process the user query. The query parsing module can be further configured to select a set of models for the scene understanding module to use to generate the frame document.

In another aspect of the inventive subject matter, an alert generating system features: a query module comprising a query parsing module, where the query module is configured to receive a user query and wherein the query parsing module is configured to determine a set of models that are required to process the user query; a scene understanding module configured to process a scene using the set of models to generate a frame document that comprises contextual information about the scene; a reasoning engine configured to carry out a rule-based check and a VLLM reasoning check based on the user query and the frame document; the reasoning engine configured to use at least one of rule-based reasoning and VLLM reasoning to generate an alert based on the user query and the frame document; and the reasoning engine further configured to transmit an alert packet to a computing device, where the alert packet causes the computing device to generate a visual notification of the alert.

In some embodiments, the query module also includes a guardrail module, where the guardrail module is configured to filter prohibited user queries from being processed. In some embodiments, prohibited user queries are filtered based on at least one of a prohibited word and a prohibited context. In some embodiments, the query parsing module is further configured to select a set of models for the scene understanding module to use to generate the frame document.

### BRIEF DESCRIPTION OF THE DRAWING

FIG. 1 is a schematic showing how different video sources can feed video content into a frame preprocessing module of the inventive subject matter.

FIG. 2 is a schematic describing frame preprocessing that occurs before passing video content on to a scene understanding module.

FIG. 3 is a schematic describing a scene understanding module of the inventive subject matter.

FIG. 4 is a flowchart describing a method of the inventive subject matter focusing on frame preprocessing and a scene understanding module.

FIG. 5 is a flowchart showing an output from a scene understanding module.

FIG. 6 is a flowchart describing how output from a scene understanding module can be used to develop alerts based on user queries.

FIG. 7 is an example of a frame document that can be generated by a scene understanding module.

### DETAILED DESCRIPTION

The following discussion provides example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used in the description in this application and throughout the claims that follow, the meaning of “a,” “an,” and “the” includes plural reference unless the context clearly dictates otherwise. Also, as used in the description in this application, the meaning of “in” includes “in” and “on” unless the context clearly dictates otherwise.

It should be noted that any language directed to a computer should be read to include any suitable combination of computing devices, including servers, interfaces, systems, databases, agents, peers, Engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network. The following description includes information that may be useful in understanding the present invention. It is not an admission that any of the information provided in this application is prior art or relevant to the presently claimed invention, or that any publication specifically or implicitly referenced is prior art.

In this application, the phrasing “at least one of X, Y, and Z” may be used. This usage is intended to mean “one or more of X, one or more of Y, or one or more of Z, or any combination of one or more of X, one or more of Y, and one or more of Z.”

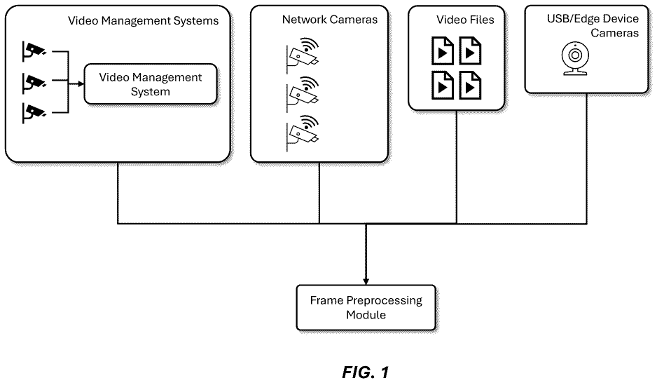

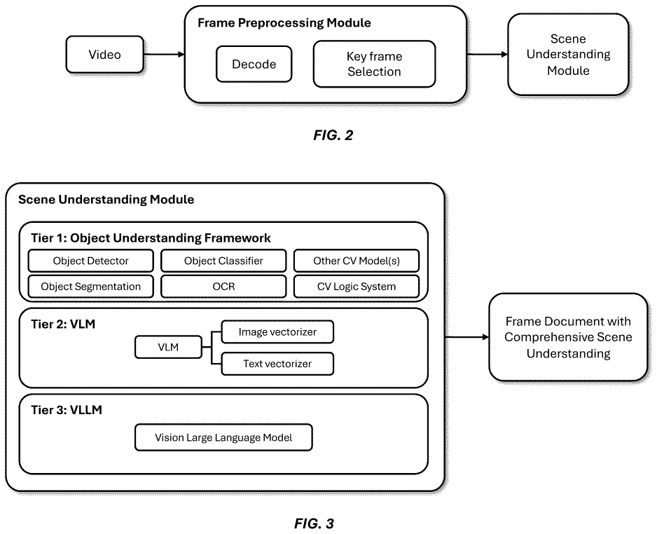

Systems and methods of the inventive subject matter take a three-tiered approach to scene understanding that includes tools to obtain deep insights of scenes that exist within videos. FIG. 1 is a schematic showing how different video sources can feed video content into a frame preprocessing module of the inventive subject matter. FIG. 2 is a schematic describing frame preprocessing that occurs before passing video content on to a scene understanding module that is described in FIG. 3.

According to FIG. 1, video content can come from a variety of sources. For example, a Video Management System (VMS) can provide video. Camera feeds are often managed by a VMS, which is responsible for recording video streams, changing settings, and providing camera feed access to external service providers. Camera feeds from a VMS can thus be fed into a frame preprocessing module of the inventive subject matter.

In other embodiments, video files that contain pre-rerecorded video can be fed into a frame preprocessing module. Video files can be stored either locally (e.g., on local storage) or remotely (e.g., on remote storage, on a server, cloud storage, or the like). This allows embodiments of the inventive subject matter to handle not only live video, but also recorded video to assist with, e.g., forensic analysis of video content.

In some embodiments, video streams from networked cameras can be fed directly into a frame preprocessing module. Directly feeding a video stream refers to passing video that is sent over a network connecting to a frame preprocessing module instead of having the video stream pass through a server or cloud, first. This can mean that a video stream is transmitted via local area network or that it passes over an internet connection in a way that it does not route through, e.g., any kind of third-party service (outside of ordinary network traffic routing).

In some embodiments, edge or USB cameras can generate video that is passed into a frame preprocessing module. These types of cameras can be configured for mobility and thus may generate video streams that need to be transmitted to different machines for processing.

In any event, a wide variety of video sources can transmit video to a frame preprocessing module of the inventive subject matter. Frame preprocessing modules can operate on a local or remote/cloud machines, or any other type of computing device configured to receive video content and that is capable of carrying out frame preprocessing tasks described in this application.

Frame preprocessing modules of the inventive subject matter are responsible for preparing video frames for processing by, e.g., computer vision models (which are incorporated into the scene understanding module described below). Frame preprocessing modules ensure that, e.g., key frames are optimized and tailored for scene understanding modules of the inventive subject matter, enhancing both computational efficiency and model accuracy. Key functions of frame preprocessing modules include decoding video streams, key frame selection, and preprocessing tasks (e.g., resizing, cropping, and so on).

Thus, according to FIG. 2, video content is passed from a video source to a frame preprocessing module. A module is a process or set of processes that exists in software, where that software can be run either locally (e.g., on a personal computer, smart device, or the like) or remotely (e.g., on a server, a set of servers, a cloud server, or the like). Video content and videos comprise scenes, such that the terms video and video content refer to any kind of video (e.g., live, pre-recorded, or any other format of video) while the term scene refers to some activity captured in a video or video content (e.g., a portion of some security camera footage, a news broadcast, home videos, YouTube videos, and so on). Videos can comprise multiple scenes, and scenes can overlap with other scenes.

The frame preprocessing module has two primary functions: decoding and frame selecting. All digital video content is encoded or compressed in some way, and video decoding is the process of converting an encoded or compressed video stream into a format that can be displayed on a screen or can be subject to further processing. When a frame preprocessing module receives video from, e.g., a video management system (VMS), from network-based cameras, from video files, from USB/edge device cameras, or the like, the video is encoded in some manner. Videos are often encoded using compression algorithms to reduce storage and bandwidth requirements, which must be decoded into raw frames to make further processing possible.

Decoding can involve using hardware or software to uncompress video and audio streams. Video passed to the frame preprocessing module can exist in a compressed format to facilitate transmission over network connections, and the frame preprocessing module can thus decode incoming video to bring it into a format that can be used by the scene understanding module.

Some common codecs include H.264/AVC (Advanced Video Coding), H.265/HEVC, MPEG-4, and MJPEG. H.264/AVC is widely used in surveillance, streaming, and storage systems. H.265/HEVC (High Efficiency Video Coding) is an advanced codec offering high compression efficiency. MPEG-4 is commonly used in multimedia applications. MJPEG (motion JPEG) is often used in video surveillance for simplicity and compatibility. Frame preprocessing modules of the inventive subject matter can be configured to handle a wide variety encoded videos, where decoding capabilities are limited only by processing power. Frame preprocessing modules should be able to handle different bitrates and frame rates in different video streams, and they should be capable of efficiently managing resource usage (e.g., hardware and software resources) to ensure decoding occurs in real time.

The second task that the frame preprocessing module carries out is frame selecting. In video surveillance, for example, frame selecting is a process by which key frames from a video stream are identified and sometimes extracted (e.g., to create a scene, as described below). This process helps in summarizing video content. In some embodiments, key frames represent and are identified according to significant changes or events in a video, while in other embodiments keyframes are selected at regular intervals, at random, by clustering procedures, or according to another selection scheme. Key frames can be used by embodiments of the inventive subject matter to, e.g., summarize surveillance videos by detecting multiple change points and segmenting the video into scenes to create concise and informative summaries video content.

Not all frames of a decoded video may be relevant to a scene understanding module. Thus, selecting frames judiciously is critical to balance computational efficiency and task accuracy. Frame rates of incoming video can be high (e.g., 30+ FPS) or low (e.g., less than 30, though generally in the range of 5-10 FPS). High frame rates can be necessary for, e.g., computer vision models that track dynamic or rapidly changing objects—such as a vehicle detection model—where object locations can change significantly between frames. Lower frame rates can be suitable for, e.g., computer vision models that analyze relatively static attributes and objects, such as a vehicle color classifier, where color information remains relatively constant over time. Key frame selection can be adjusted depending on video frame rate as well as expected content in a video (e.g., if high speed movements are expected, more key frames may be selected to ensure those movements are adequately captured in the selected key frames).

A variety of frame selection techniques can be implemented, including uniform sampling and dynamic sampling. With uniform sampling, the frame preprocessing module selects frames at fixed intervals. With dynamic sampling, the frame preprocessing module selects frames at variable intervals, where the selection rate can be adjusted according to requirements of, e.g., a computer vision model deployed in a scene understanding module, other aspects of the scene understanding module, content of the video that key frames are being selected from, and so on.

Clustering methods can also be implemented to give rise to intelligent frame selection. Algorithms like K-means, DBSCAN, and other hierarchical clustering techniques can be used to group similar frames based on features such as color histograms, edge patterns, or deep feature embeddings. Representative frames from each cluster are then selected as key frames to ensure diversity in key frames while minimizing redundancy. This approach can be useful for summarization tasks or when processing long, unchanging scenes, as it prioritizes capturing key variations without unnecessary duplication.

Key frames that the frame preprocessing module identifies correspond to scenes in videos. Key frames are representative of scenes. In some embodiments, a set of key frames corresponds to a scene that comprises multiple frames around each key frame in the set of key frames or that is bounded by the keyframes (e.g., a scene can be a segment of a video that starts at a first key frame in a set and ends with a last key frame in a set), and in some embodiments a set of key frames that are selected make up a scene. For example, if a scene is 350 frames long, then the set of key frames can have 350 frames. In some embodiments, key frames the frame preprocessing module identifies can be some subset of the total frames making up a scene (e.g., such the key frames making up a scene can playback the scene at a lower frame rate than the video the scene came from would ordinarily playback at).

In some embodiments, key frames can be passed to the scene understanding module as they are extracted from a video, and whether a set of key frames makes up a scene (and what key frames should be in that set) can be determined after processing by the scene understanding module has taken place. This can be true in circumstances where characteristics that define a scene cannot be known until after key frames have been fully processed and understood. For example, it may be useful to create a scene from a video where the scene includes every key frame where a scene is one in which a red ball appears, and that information cannot be known until the key frames are fully processed and the “scene” has been understood—then it can be identified as a scene. How quickly key frames can be passed to a scene understanding module from a frame preprocessing module can depend on available processing power—more processing power facilitates faster key frame selection and faster key frame processing.

Thus, because embodiments of the inventive subject matter operate in real time, key frames can be sent from the frame preprocessing module on an individual basis as a video is received by a frame preprocessing module. Because in most circumstances, key frames selected by the frame preprocessing module are a subset of total frames in a video, the scene understanding module can then receive each key frame and carry out its scene understanding tasks (as discussed below) without processing slowdown that may occur if every single frame from a video is sent to the scene understanding module. Thus, when describing a “set of key frames” as being transmitted to the scene understanding module, it should be understood that this process can occur over a period of time where each key frame in the set is sent to the scene understanding module for further processing sequentially.

After the frame preprocessing module selects frames (e.g., as each key frame is selected, preprocessing can be carried out essentially in real time), each selected key frame can undergo additional preprocessing to align with specific requirements of a scene understanding module (e.g., requirements of computer vision models incorporated into a scene understanding module). Additional preprocessing can involve resizing, cropping, low-light enhancing, and other model-specific preprocessing (e.g., preprocessing that accounts for aspects of a scene understanding module that will process the key frames). Resizing can be used to adjust frame dimensions to match an input size that a scene understanding module expects (e.g., resizing to 224×224 pixels for classification models such as ResNet). Cropping can be used to extract or limit a frame to specific regions of interest (ROIs) to eliminate irrelevant information so that a target area can be focused on by a scene understanding module. Low-light enhancing involves altering frames captured in poor light conditions to improve scene understanding module performance (e.g., computer vision model performance) in low-visibility scenarios.

In some embodiments, frame preprocessing modules can perform edge detection or blurring. For example, edge enhancement and Gaussian blurring can be applied to frames to improve performance of a scene understanding module that receives them. Color space conversion can also improve scene understanding module performance. By converting all or portions of key frames to alternative color spaces like HSV (hue, saturation, and value), HSL (hue, saturation, and lightness), or grayscale, scene understanding modules of the inventive subject matter can operate more efficiently depending on the tasks undertaken.

Thus, frame preprocessing modules of the inventive subject matter can carry out the tasks described above, which includes decoding, frame selecting, and video preprocessing before transmitting preprocessed key frames (e.g., sequentially, in real time, as a set, etc.) to a scene understanding module. In some embodiments, the frame preprocessing module can be implemented on the same hardware and can even be part of the same software implementation as the scene understanding module. Thus, although the term “transmit” may be used to describe sending key frames from a frame preprocessing module to a scene understanding module, because modules exist as software implementations, the term can be considered as describing the ability of software of the inventive subject matter to use key frames once those key frames have been identified by the frame preprocessing module of the same software (or different software in instances where, e.g., different software tasks are distributed across different computing devices).

Scene understanding modules of the inventive subject matter, as shown in FIG. 3, feature a multi-tiered approach to scene understanding, which includes tools that help to obtain deep insights of scenes that are passed to the scene understanding module from the frame preprocessing module. Tier 1 implements an object understanding framework, Tier 2implements a VLM (e.g., OpenCLIP, CLIP, ALIGN, ViLT, or the like), and Tier 3 implements a VLLM (Vision Large Language Model). A scene understanding module of the inventive subject matter thus receives key frames that has been preprocessed by the frame preprocessing module so that each tier within the scene understanding module is able to process those key frames more efficiently.

Key frames are processed by each of the tiers, starting with Tier 1. Tier 1 receives preprocessed key frames from the frame preprocessing module and creates an object level understanding of what is shown in the key frames (and by extension in a scene that the key frames represent). Tier 1 can thus facilitate detection and generation of alerts according to predefined rules and settings. For example, an alert can be set to trigger when a car is detected in one or more of the key frames of a scene, and a car can be detected according to an object understanding framework implemented in Tier 1.

The object understanding framework in Tier 1 is configured for high key frame throughput capacity with support for multiple, simultaneous real-time streams. It can process key frames to carry out tasks including object detection, object classification, and OCR. Because it is a highly optimized pipeline, an object understanding framework implemented by Tier 1 can be capable of processing multiple key frames per second without any drop in performance. Thus, Tier 1 carries out basic object identification tasks.

Tier 1 (i.e., the object understanding framework) features a number of sub-modules, including one or more object detectors, one or more object classifiers, an object segmentation module, an OCR module, a computer vision logic system, and other computer vision models. Each of these modules can work together or separately as needed to create an output that can facilitate deep understanding of a scene.

Although in some embodiments, certain sub-modules act before or after other modules, it should be understood that no specific order of operations for sub-modules can be elucidated because how an object understanding framework prioritizes use of its sub-modules is embodiment and circumstance dependent. Though while sub-module order depends on a domain or a use case, in most instances object detection comes first, followed by object segmentation to get more accurate boundaries of a detected object. In some embodiments, though, a Segment Anything Model (SAM) can be implemented. SAM models can segment out all important objects in a set of key frames without using a separate object detector.

Object detector modules are responsible for detecting objects that exist in key frames. Object detection is a technique that uses neural networks to localize and classify objects in images. It involves training computers to see as humans do, specifically by recognizing and classifying objects according to semantic categories. Object detection combines subtasks of object localization and classification to simultaneously estimate the location and type of object instances in one or more key frames.

Object segmentation, also known as image segmentation, is the process of partitioning a digital image into multiple image segments, also known as image regions or image objects. The goal of segmentation is to simplify and/or change the representation of an image into something that is more meaningful and easier to analyze by, e.g., isolating an object in a key frame. This technique is typically used to locate objects and boundaries (lines, curves, etc.) in images. Each of the pixels in a region are similar with respect to some characteristic such as color, intensity, or texture. Thus, an object segmentation module is responsible for carrying out object segmentation for objects that appear in key frames.

In some embodiments, an OCR module is also included. An OCR module can be responsible for recognizing and extracting text from key frames. OCR modules of the inventive subject matter can be implemented to enable text searching within key frames of a scene that is subject to processing by a scene understanding module (and specifically Tier 1 of the inventive subject matter).

Object understanding frameworks can also include computer vision (CV) logic systems. Computer vision logic systems are designed to enable computers to interpret and understand visual information. These systems can use a combination of image processing, machine learning, and deep learning techniques to analyze images and videos. They can perform tasks such as object detection, image classification, and scene understanding. Embodiments thus implement computer vision logic systems to facilitate scene understanding. For example, once object detection and segmentation have taken place for a key frame, a computer vision logic system can make sense of objects present in the key frame and, as more key frames are analyzed, a computer vision logic system can also discern information relating to how multiple objects interact in a scene.

Computer vision logic systems receive an input and produce and output. Inputs can include outputs from computer vision models (e.g., computer vision models that act as detectors, at as classifiers, create segmentations, and so on) and regions of interest (ROI) that are either predefined or given by a user. A computer vision logic system is thus responsible for gathering rule-based information (e.g., about one or more objects) from key frames, including: a tracking ID, a location of an object, a duration that an object appears in a scene as represented by key frames, an indicator as to whether an object is moving or stationary, a direction of movement, and whether an object is in a region of interest. Outputs from a computer vision logic system can be used for, e.g., alert generation.

Object understanding frameworks of the inventive subject matter implement a number of features that improve efficiency. For example, in some embodiments, smaller computer vision models can be used. Ordinarily, computer vision models are trained using a machine learning library. For example, PyTorch can be used to enable quick and easy model training. PyTorch is an open-source machine learning library for Python developed by Facebook's AI Research Lab (FAIR). It is one of the most popular deep learning frameworks, alongside others such as TensorFlow and PaddlePaddle. PyTorch offers a rich ecosystem of tools and libraries that support development in computer vision, natural language processing (NLP), and more.

Trained computer vision models can have assigned weights in, e.g., FP32 format. FP32, also known as single-precision floating-point format, is a computer number format that occupies 32 bits in memory. It represents a wide dynamic range of numeric values by using a floating radix point. This format is commonly used in scientific calculations and AI/deep learning applications. FP32 consists of 1 bit for the sign, 8 bits for the exponent, and 23 bits for the mantissa, allowing it to represent numbers with approximately 7-9 significant decimal digits. Quantization can then be used to convert computer vision models to use either FP16 or INT8 weights. This reduces model size and increases inference speed without giving rise to meaningful impacts to accuracy. Another way of reducing model size and increasing inference speed is through distillation. Trained computer vision models (i.e., teacher models) can be used further to train smaller computer vision models (i.e., student models).

In some embodiments, computer vision models can be designed to efficiently use available resources. Because multiple computer vision models can be used in a scene understanding module, object understanding frameworks of the inventive subject matter can be optimized to minimize data transfer from host (e.g., CPU) to device (e.g., GPU) and vice versa. Parallel processing can also be implemented so that independent computer vision models can run simultaneously.

An object understanding framework of Tier 1 thus uses all or a subset of the identified sub-modules to discern information about objects that appear in key frames that correspond to a scene. Object metadata that can be generated can include rule-based enrichments such as a tracking ID, a size/aspect ratio, a location (e.g., bbox, center), whether the object is stationary or moving, a movement direction (if applicable), an indicator as to whether an object exists within an ROI, and a duration that an object is present within a scene as represented by a set of key frames. Model based enrichments can also be generated, including an object crop embedding vector, object specific attributes, object segmentations, and so on.

Once key frames have been processed according to Tier 1, objects in the key frames will have been identified and segmented, any text will have been recognized via optical character recognition (OCR), and interactions between objects in the key frames will be discerned and understood. In the broader context of computer vision, understanding object interactions means recognizing how objects within key frames interact with each other over time. This involves tracking objects, analyzing their movements, and understanding their behaviors and relationships. For instance, in surveillance video content, understanding object-object and human-object interactions is fundamental. Visual tracking algorithms follow objects manipulated by humans as well as objects that are impacted or affected by other objects, providing useful information to model such interactions. This capability is essential for applications like surveillance, where recognizing and understanding interactions between humans and/or objects in a scene or video can enhance interaction realism. Thus, Tier 1 generates object information, where object information can include any of the parameters, metadata, or information about an object discussed regarding Tier 1.

Tier 2 implements a Vision and Language Model, or VLM (e.g., OpenCLIP, CLIP, ALIGN, ViLT, or the like) that can use the object level understanding developed in Tier 1 to vectorize objects (e.g., images cropped to show only or predominantly the object) and images (e.g., images containing visual information that a user may want to search for) within the key frames, and in some cases to vectorize entire key frames. Thus, outputs from Tier 1 can be used in Tier 2 in several ways. For example, Tier 1 outputs can facilitate vectorizing cropped images that contain objects (e.g., for use with text-based image searching or with VLLM processing in Tier 3). One or more of the sub-modules in Tier 1 can detect objects (e.g., vehicles, people, traffic lights, posters, road signs, etc.) and then create bounding boxes around those objects. The bounding boxes can then be cropped and resized (e.g., to a VLM's required image input size) before being vectorized using a VLM's image encoder.

Objects are detected and preprocessed (e.g., cropped, resized, etc.) before being vectorized because many VLMs need images to have specific dimensions (e.g., 224×224 pixels) before they can be processed. Thus, in embodiments of the inventive subject matter, objects in a key frame are each cropped and vectorized separately so that information is not lost in resizing. In some instances, a full key frame without any resizing or cropping can be vectorized, which can facilitate searching or VLLM processing that captures more information about a scene (e.g., “find a scene showing a road crossing on a rainy day”).

By carrying out the vectorizing tasks described above, a VLM (e.g., OpenCLIP, CLIP, ALIGN, ViLT, or the like) can be used to relate natural language (e.g., user queries or VLLM queries) with key frames and objects in those key frames making it possible to conduct text searches for those objects. A VLM of the inventive subject matter can be configured to accommodate multiple real-time streams of key frames—where rate that key frames can be processed depends on, e.g., frame selection that occurs in the frame preprocessing module—simultaneously without sacrificing video processing capabilities. When Tier 2 is described in this application as handling or processing key frames (or similar language), it should be understood that Tier 2 is vectorizing objects, images, and, in some cases, entire key frames.

Tier 2's high throughput capabilities can be useful in, e.g., embodiments where multiple security cameras are fed into one or more frame preprocessing modules and resulting key frames are passed to a single scene understanding module (e.g., a scene understanding module running on restricted hardware environment like a personal computer). A VLM implemented in Tier 2 can be tuned using application and domain specific datasets (e.g., datasets that relate objects that appear in images to text that are sourced from, for example, surveillance footage). And VLMs of the inventive subject matter can feature at least two modules: an image encoder and a text encoder. VLMs can use those encoders to vectorize images and text to facilitate vectorized searching and VLLM processing.

A practical example of a VLM model is one developed by OpenAI, CLIP, which is trained on a variety of (image, text) pairs. OpenAI's model can predict the most relevant text snippet given an image, without directly optimizing for the task, similar to the zero-shot capabilities of GPT-2 and GPT-3. The VLM can be fine-tuned to custom datasets and is capable of performing tasks such as image classification and finding the similarity between an image and a set of text descriptions. Tier 2 thus uses output from Tier 1. Where Tier 1 detects objects, Tier 2 vectorizes those objects to facilitate text-based object searching. For example, a searchable interface could be provided that is overlaid over video content as it plays.

By vectorizing images containing objects that are present in key frames, Tier 2 makes it possible to use language to associate objects with other objects (e.g., objects or people). By linguistically associating objects with other objects that appear in a set of key frames, events that occur in the corresponding scene can be better described.

Because key frames (e.g., segmented objects within key frames, entire key frames, etc.) have been processed according to Tier 1 and then vectorized according to Tier 2, efficient text-based searches or text-based VLLM processing of scene content is made possible. Vectorized searching, also known as vector search, is a method in artificial intelligence and data retrieval that uses mathematical vectors to represent and efficiently search through complex, unstructured data. Unlike traditional keyword-based search methods, vector search represents data points as vectors in a highly-dimensional space, allowing for more sophisticated and accurate searches. This method is particularly useful for finding related data by comparing the similarity of query vectors to data vectors, often using algorithms like cosine similarity or Euclidean distance.

Thus, when objects are identified in key frames and then vectorized, natural language queries can be received, vectorized, and used to search through key frames to find images or objects in a scene. For example, users can conduct vector searches that can match queries to the most relevant vectorized object(s) in a scene. Vectorized searching can also be used to generate contextualized descriptions of how multiple objects in a scene interact with one another (e.g., “show a red car colliding with a blue car”).

As mentioned above, Tier 2 can vectorize object image crops and/or full key frames to facilitate text-image and image-image search. A text-image search is one where a text query is input and an image result is returned, and an image-image search is one in which a user uploads an image of an object and an image result is returned.

In addition to vectorized searching, Tier 2 facilitates processing by a VLLM in Tier 3. Tier 3 implements one or more VLLMs (Vision Large Language Models) to carry out additional scene processing to attain a contextualized understanding of a scene. A VLLM is a type of multimodal model that is capable of interpreting both visual and textual information. VLLMs can be commercially distributed (e.g., GPT) or open source (e.g., InternVL2, Qwen2-VL, etc.). Open source VLLMs can be useful for customization and fine-tuning purposes. Other suitable multimodal models capable of interpreting at least both visual and textual information can be used in some embodiments, and multimodal models capable of interpreting other information types in addition to visual and textual, including audio, can be implemented in some embodiments.

In general, the VLLM implemented in Tier 3 will be slower and less accurate for tasks that are undertaken by, e.g., Tier 1, which is why those tasks are taken out of the purview of Tier 3 in the first place. For example, object or text detection and segmentation can be handled by a VLLM, but because VLLMs require far more computing resources than the dedicated sub-modules that can exist in Tier 1, Tier 1 is responsible for those tasks. Moreover, outputs from Tier 1 can strengthen reasoning capabilities of VLLM models in Tier 3. For instance, a VLLM could miss a smaller object that appears in a video, but the specialized sub-modules in Tier 1 may not have issues detecting that same object, and when a small, miss-able object is detected in Tier 1, it ensures that object can be interpreted by a VLLM in Tier 3.

Tier 1 outputs (e.g., bounding box locations of an object, an augmented form with an object segmented out to have a specific highlight color, or each object annotated with a tracking ID, or the like) can thus provide extra information that helps a VLLM in Tier 3 to better understand a scene. For example, say there are five cars in a four-lane road. Tier 1 could detect all the cars, draw bounding boxes around them, and associate tracking IDs with each of the cars. This task ensures that the VLLM in Tier 3 considers all five of the cars when the VLLM on its own might not have detected all five.

In some situations, VLLMs are not good at detecting domain specific objects (i.e., objects that exist within a pre-defined set of objects such as medical images, vehicles, and so on). But Tier 1 can find domain specific objects more easily because Tier 1 is configured specifically for object detection, regardless of object domain.

VLLMs of the inventive subject matter can be configured to carry out open vocabulary object detection. Thus, in general, VLLMs can receive different types of input, including a query in the form of one or more of any of an image (or a set of images), and/or text, where the text could be a simple question or a complex instruction. For example, a VLLM can receive an object description as text and use that object description to output bounding boxes containing the described object. In this way, a VLLM can make user-specified object detection unnecessary. For example, a user might not know all objects that should be detected in a set of key frames. A VLLM, on the other hand, does not need a list of objects to detect and can instead detect objects in key frames as needed. VLLMs are comparatively slower than traditional detectors and classifiers, which is why Tiers 1 and 2 carry out tasks to minimize how much processing power will be required by a VLLM to carry out the tasks of Tier 3. VLLMs of the inventive subject matter are thus configured to receive an image or video along with text (or just text) as a query and to generate a text answer as an output. The output can be formatted as, e.g., JSON, plain text, and so on, and it can be included in a detailed frame document that scene understanding modules of the inventive subject matter are configured to generate.

Because VLLMs can simultaneously process both text and images to provide a textual output, scene understanding modules of the inventive subject matter are capable of using key frames to generate in-depth textual descriptions of a scene that are further enriched using information available via Tier 1 and Tier 2 processing. Tier 2 output can optionally be used in Tier 3, depending on Tier 3 model architecture as discussed below regarding image encoding. Although VLLMs can provide information regarding objects and their interactions, VLLMs are not deterministic, which can make them unreliable. To keep VLLMs grounded, so to speak, information from Tier 1 can be used to minimize instances of a VLLM deviating from reality by focusing it on objects that Tier 1 has identified.

A distinguishing feature of VLLMs is their ability to perform tasks requiring high-level reasoning across both text and visual modalities. For instance, they can generate detailed captions for images, provide in-depth explanations for visual content, or engage in multi-turn dialogues that incorporate visual context. The incorporation of LLMs like GPT within VLLMs allows for rich contextual interpretation, enabling tasks such as storytelling from images, answering detailed questions about visual scenes, and providing multimodal reasoning in fields like education, healthcare, and creative content generation. This synthesis of vision and language capabilities positions VLLMs as transformative tools for a wide range of applications.

Modern VLLMs tend to be slow, owing to trade-offs between size and performance. VLLMs are also generally capable of processing only a single real-time stream at a much lower frame rate. Because of these limitations, scene understanding modules of the inventive subject matter take the three-tiered approach described in this application. By running video content or scenes through Tiers 1 and 2 before applying a VLLM in Tier 3, the Tier 3 VLLM can run more efficiently because, in some embodiments, it would not need to carry out any of the tasks already performed by Tiers 1 and 2.

VLLMs use an image encoder to understand images. In some cases, a VLLM can use a VLM (e.g., OpenCLIP, CLIP, ALIGN, ViLT, or the like) as an image encoder. Because VLMs are bimodal and can handle both images and text, embodiments that use a VLM for image encoding give rise to two types of VLLM architectures: VLLMs that keep the image encoder frozen and only fine-tune the language model part, and VLLMs that fine-tune both the image encoder and the language model.

In embodiments where Tier 3 requires a VLM image encoder that has been frozen and not fine-tuned, then the VLM from Tier 2 can be used for image encoder (e.g., OpenCLIP, CLIP, ALIGN, ViLT, or the like). In other words, in some situations, the image encoder used in Tier 3 can be taken from Tier 2 in situations where the image encoder from the VLM in Tier 2 is also adequate for Tier 3.

Reusing the VLM from Tier 2 can reduce hardware resource consumption and improve efficiency. But where Tier 3 requires a VLM image encoder that is different from the VLM image encoder in Tier 2, then the VLM image encoder in Tier 2 is no longer considered to exist in the same space as the VLM text encoder and it instead enters the space of the VLLM. In such situations, the VLM encoder cannot be reused from Tier 2. In other words, if Tier 3 has image encoding requirements that cannot be satisfied by the VLM image encoder from Tier 2, then the Tier 2 VLM image encoder cannot be reused in Tier 3. A VLLM in Tier 3 can thus be configured to associate text queries with contextual information from key frames that are processed by Tier 1 to gather information about, e.g., weather, lighting, background, foreground, or other user defined parameters. Tier 3 text queries are set (e.g., pre-defined) before processing begins, and they can be applied to all key frames. Outputs from these queries can then be used in creating a frame document that the scene understanding module is configured to output.

An example query that can be applied in Tier 3 is: “describe the weather, lighting, background objects, foreground objects.” A scene understanding module of the inventive subject matter could incorporate a response to this query in a frame document. For example, when applying this query to key frame, the response to the query could be: “The weather is sunny, and the lighting is good. There is a billboard in the background. In the foreground are two persons.”

Thus, Tier 3 can use one or more VLLMs to generate general scene context and domain specific scene context. General scene context includes contextualized text descriptions of a scene (e.g., based on processing undertaken using key frames corresponding to the scene), foreground objects, background objects, weather, lighting, signs and posters, and so on. Domain specific scene context can include general scene descriptions.

Once all Tiers 1, 2, and 3 have been applied via the scene understanding module, the scene understanding module outputs a detailed frame document that features comprehensive scene understanding. Frame documents of the inventive subject matter can be formatted as, e.g., JSON, text, or the like. Frame documents can be formatted for human user consumption (e.g., arranged and formatted in a way that is easy for a user to interpret and understand), they can be formatted to contain information in one or more data structures that are conducive to information storage and later retrievable by a computer, or, in some embodiments, both. Outputs from scene understanding modules of the inventive subject matter can, for example, be used to create a user interface having a search feature that allows users to use plain language text searching to search through video content.

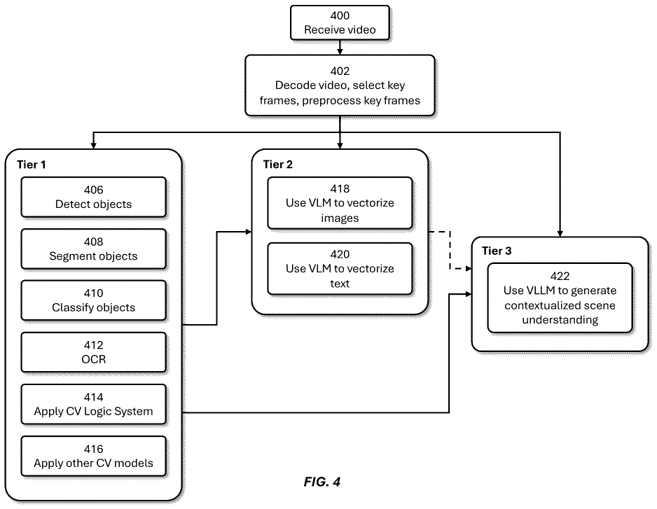

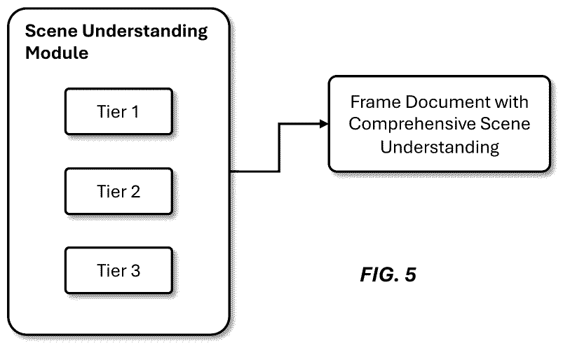

FIG. 4 is a flowchart demonstrating how a method based on the inventive subject matter described in this application can be organized. It should be understood that embodiments described in relation to FIGS. 4 and 5 can incorporate all subject matter described in this application as it relates to different method steps, whether explicitly restated in describing these method steps or disclosed above in the context of FIGS. 1-3.

In step 400, video is received by a frame preprocessing module from a video source. Possible video sources are described above in FIG. 1. The frame preprocessing module exists on, e.g., a computing device or set of computing devices, whether local, remote, cloud, etc. In step 402, the frame preprocessing module decodes the video and selects key frames from the decoded video. In some embodiments, the frame preprocessing module can perform further preprocessing by, e.g., resizing key frames, cropping key frames, and so on, as described above.

Once the frame preprocessing module has completed its tasks, key frames are ready for additional processing by Tiers 1, 2, and 3. Each key frame is thus subject to the object understanding framework of Tier 1, which includes several steps. Step 406 describes object detection, step 408 describes object segmentation, step 410 describes object classification, step 412 describes applying optical character recognition (OCR), step 414 describes applying a computer vision logic system, and step 416 describes applying other computer vision models (which can be done on an as-needed basis). Each of steps 406-416 are described in detail above and in relation to Tier 1's object understanding framework. In some embodiments, not every one of steps 406-416 must be carried out for Tier 1 to be considered complete.

Once Tier 1 processing is complete, and an object level understanding of each key frame has been developed. Tiers 2 and 3 can then use information from Tier 1 to conduct further processing. Although Tiers 1, 2, and 3 are not shown as operating in sequence (e.g., arrows from step 402 go to each of the Tiers individually), it should be understood from discussion of the Tiers presented in this application that, in some embodiments, processing that takes place within individual Tiers can be used in other Tiers in sequence.

Tier 2 uses a VLM to carry out its steps. In step 418, the VLM vectorizes (sometimes describes as “encoding”) images, and in step 420, the VLM vectorizes text. The images vectorized in step 418 can include key frames or portions of key frames. For example, if an object is segmented out in Tier 1, then the segmented image may be vectorized, while in other circumstances entire key frames are vectorized. Text that can be vectorized includes text content that appears in a key frame or segmented key frame. For example, if in step 412, text on a sign that appears in a key frame is subject to OCR, then that text can be vectorized in step 420.

Metadata text generated in Tier 1 can also be vectorized. For example, object classification carried out in step 410 can generate object classification metadata (e.g., a text-based object description), and that object classification metadata can then be vectorized in step 420. Text and image content that is vectorized in steps 418 and 420 can be used in Tier 3 as well as in a frame document that the scene understanding module generates, as described in FIG. 5.

Tier 3 features step 422, which involves using a VLLM to generate a contextualized scene understanding. As discussed above, the VLLM in Tier 3 runs pre-defined queries that generate contextual information about content in key frames (e.g., weather, lighting, and so on as described above). Carrying out Tiers 1 and 2 before moving to Tier 3 can improve the performance of step 422 in Tier 3 for the reasons discussed above in more detail.

Once Tiers 1-3 (and steps 406-422) have been applied to key frames, the scene understanding module (which comprises Tiers 1-3) can generate a frame document having comprehensive scene understanding. Thus, for example, the frame document can include object understandings and metadata generated in Tier 1, it can include vectorized images and text generated in Tier 2, and it can include contextualized scene information generated in Tier 3. In some embodiments, the contextualized scene information can incorporate information form Tiers 1 and 2.

Scene understanding modules as described in this application give rise to many different systems and methods, including alert generation. Because some uses for embodiments of the inventive subject matter are in surveillance and security, the ability to generate alerts based on occurrences, actions, objects, object interactions, etc. that appear in surveillance footage is valuable. In such embodiments, users can input queries that ask for alerts when certain circumstances, actions, objects, and so on exist in some video content (e.g., in a scene as identified by key frames as described above). These user queries are first parsed to determine how best to process the queries, and after parsing, they can be subject to filtration and/or validation.

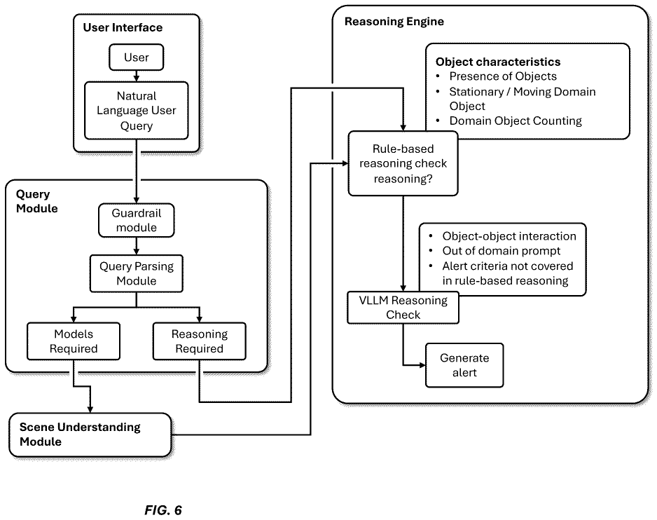

FIG. 6 shows a system schematic for an alert generation system that leverages a scene understanding module as described in this application. Systems that facilitate alert generation begin with a user interface. User interfaces of the inventive subject matter are configured to receive text input from a user, where the text input is written in natural language. As with modules, user interfaces of the inventive subject matter should be understood as being software implementations that interact with hardware to cause a display to show a user interface that allows a user to provide input via keyboard, voice, handwriting, or the like.

Thus, users can input natural language queries to generate insightful responses about a video, a scene, multiple videos, or multiple scenes. User queries can be interpreted as defining alert conditions. For example, a user query can be formed as requesting an alert for “an individual loitering near a restricted area” or “a bag left unattended in a crowded location.” The user interface shown in FIG. 6 can interpret natural language and use it to create machine-interpretable alert criteria.

Machine-interpretable alert criteria means criteria or conditions derived from user queries that can be understood and processed by, e.g., a machine learning model. These criteria can be structured in a format that facilitates detection, monitoring, and alert triggering for specific events or patterns within video content. For example, an embodiment of the inventive subject matter can convert natural language queries (e.g., “generate an alert whenever an individual is seen loitering near a restricted area”) into parameters such as: output type: alert; alert criteria: loitering activity; location type: restricted area; time threshold: duration of inactivity or wandering.

Once machine-interpretable alert criteria are generated, the machine-interpretable alert criteria are passed to the query module. Query modules of the inventive subject matter include guardrail modules that are configured to ensure users stay within predefined bounds. For example, alert systems of the inventive subject matter can, in some cases, be used for nefarious, unlawful, unintended, or otherwise unauthorized purposes. To combat such uses, embodiments can include a guardrail module. Guardrail modules of the inventive subject matter can be configured to verify and filter queries to confirm the queries comply with ethical and operational standards to prevent misuse or biased surveillance and to ensure queries are feasible within system constraints. In some embodiments, guardrail modules can additionally filter profanity and prevent users from generating alerts for obscene content. Guardrails can also be employed to prevent users from submitting queries for sensitive data, and they can prevent users from modifying or deleting database content.

Ethical standards can be set by establishing a variety of parameters, including keyword prohibitions and contextual prohibitions. For keyword prohibitions, guardrail modules can catch and stop queries that comprise forbidden keywords from being used to generate alerts. Contextual prohibitions can, e.g., leverage an LLM to catch certain types of queries regardless of the way the query is phrased. Contextual prohibitions can prevent users form circumventing keyword prohibitions. For example, if a keyword prohibition exists against the words “red” and “suitcase,” and a contextual prohibition is written as, “do not allow users to set alerts that show red suitcases,” then, if a user submits a query that asks, “generate an alert any time a scene includes a burgundy carry-on,” the contextual prohibition can prevent that query from being processed, despite the query excluding either prohibited keywords.

A guardrail module can also be used for fine-grained alert filtration or modification. For example, if a user query asks to generate an alert whenever a child is seen, a guardrail module can filter the results to only show those alerts where a child is seen without an accompanying adult.

Guardrail modules thus enforce “guardrails” that amount to a set of checks that can be performed on user query before the query can be processed to ensure, for example, that an embodiment of the inventive subject matter adheres to local and international laws governing surveillance and data processing.

Guardrails enforced by a guardrail module can be determined based on a number of factors, including system capabilities. For example, as described throughout this application, a user query can request to generate an alert based on a video stream. In some embodiments, guardrails can be imposed on a per-organization basis rather than on a per-jurisdiction basis. Some organizations may not want their users to generate alerts based on, for example, race. In another example, an organization may want its users to generate alerts when construction workers are present in a scene. Guardrails can thus be implemented to limit what alerts user can set, which can be deployed in consideration of ethical and privacy concerns.

A guardrail module can carry out several steps. Although the guardrail module is shown in FIG. 6 as operating before the query parsing module, it should be understood that information from the query parsing module can be used by the guardrail module. For example, when a user submits a query, the query may be subject to query parsing before the guardrail module operates on the query, because query parsing is where a query may be broken down into constituent components that may be subject to, e.g., modification or filtration. Once a query is parsed, it will be evident if a query asks for content that should give rise to rejection (e.g., a forbidden word, forbidden content, or an attempt to modify or delete content from a database).

After a user query is subject to the guardrail module, and the guardrail module validates that the query should be processed, the query is considered validated. A query that should be validated is one that does not get filtered by the guardrail module. A validated query is then subject to parsing in a query parsing module. As indicated in FIG. 6, the query parsing module determines what models are required and whether reasoning is required for a given query.

Query parsing refers to the process of interpreting and processing queries, where queries of the inventive subject matter involve both visual and textual elements. For example, a query might include a text description and an image, and the query parsing module would parse the query to understand what types of models would be necessary to process the query (e.g., to generate alerts based on the query). This involves using models like OpenCLIP, CLIP, ALIGN, and ViLT to vectorize objects and images within key frames, facilitating text-based searches and further processing by VLLMs.

The query parsing module can operates in a low resources mode or a high resources mode. For example, in a low resource mode of operation, only those models required to create an alert that are defined in query are used. In low resources mode, the query parsing module can determine a limited set of models to run. In such cases, many other models that could be run are not run, which can limit a system of the inventive subject matter from operating with all its potential features or functions. In a high resources mode of operation, because enough resources are available, a scene understanding module can use more models to gather more contextual information than are strictly required. Since all relevant models are running, other features can run also be supported.

Once the query parsing module has determined that artificial intelligence models are needed to generate an alert based on the query, the query parsing module must then identify and select those models. A “model” as used in this application refers to any of the machine learning models involved in systems and methods of the inventive subject matter. Including object detectors, object classifiers, CLIP models, VLLMs, and any other model disclosed as a sub-module within Tier 1 of the scene understanding module. Object detectors (e.g., YOLO, RT-DETR, etc.) can be configured to detect categories of objects such as vehicles, people, traffic lights, and so on. But these detectors can fail to detect domain specific objects like spreaders in seaports, harnesses in constructions sites, and so on. For domain specific objects, fine tuning can be carried out by training an object detector using a custom dataset that features domain specific objects that the detector should be able to detect.

Object classifiers (e.g., ResNet, MobileNet, etc.) are types of machine learning models used to identify and categorize objects within images or video frames. Object classifiers work by analyzing visual data and assigning labels to different objects based on their features. Different domains can require different kinds of object classifiers. For example, in the context of road safety, an object classifier that is capable of classifying vehicle type and color may be required. Object classifiers can also include action classifiers. For example, an action classifier may be needed in the context of images or videos from city scenes, where it may be useful to determine whether a person in a video is sitting, standing, lying down, etc.

CLIP models, as discussed above, are multimodal models that can vectorize images and later use those vectorized images for, e.g., text-based image searches. Image vector quality can depend on image quality. For example, before vectorization, an image may be resized to a resolution that a model can handle as an input (e.g., 384×384). Reducing an image's resolution may lead to information loss especially of small objects present in a key frame. For example, when a query asks for “a person wearing sunglasses” in a frame with a low resolution where the person in sunglasses in the frame appears in a small portion of the frame, the query may not yield a result that features the person wearing sunglasses in the frame.

This issue can be mitigated by vectorizing key frame crops instead of entire key frames. If each individually detected object is subject to cropping and subsequent vectorization, then the amount of visual information that is vectorized is reduced, which means the visual information in a resized image relates almost entirely to an object instead of to an object with extraneous background information. This enables searches based on smaller features on an object. For example, a coffee cup is subject to cropping, then features on the face of the coffee cup can become searchable, whereas if no cropping took place, then content on the face of the coffee cup may not be visually distinguishable once frame resizing has taken place, making those features unsearchable.

VLLMs, as described throughout this application, are another type of model. All publicly available VLLMs are trained on general data, and they do not have domain specific knowledge. For example, in the context of seaports, the definition of an object called a “spreader” differs from a meaning that can be ascribed to that word according to the plain and ordinary meaning of the term “spreader.” VLLMs can thus be fine-tuned to introduce domain-specific (and, therefore, context specific) knowledge.

Artificial intelligence models that are identified for selection should be capable of conducting visual analyses necessary to evaluate a validated query (e.g., necessary to carry out whatever tasks are needed by the scene understanding module). For example, some queries may require basic object detection, object classification, or vision-language embedding models to conduct visual analysis needed to evaluate the query, and the query parsing module can make that determination. Other models that can be identified for use in processing a query are discussed in more detail regarding the scene understanding module, above.

By identifying what models a scene understanding module needs to process a validated query, the query parsing module can pass instructions to the scene understanding module along with the validated query to ensure the validated query is processed properly (e.g., using the identified models) in the scene understanding module. Thus, each of the sub-modules described in Tier 1 of the scene understanding module can include a model that is selected for its usefulness in processing a query. Accordingly, the number of sub-modules included in Tier 1 of a scene understanding module can be dynamic and based on query processing needs as identified in the query module. In addition to Tier 1 sub-modules, a specific VLLM can be selected for use in Tier 3 of the scene understanding module.

To achieve necessary flexibility and depth of analysis, embodiments can use a multi-stage model training strategy. In some instances, for example, available models lack domain specific knowledge or understanding. So although an object detector might be needed to process a validated query, it may be the case that a specific object detector that is accessible to a particular implementation of an embodiment of the inventive subject matter is poorly suited to detect objects in scenes that are anticipated by that embodiment. For example, if a system is set up to surveil industrial equipment storage, an object detector may not be well-suited to detect the industrial equipment that will appear in scenes that will be subject to processing and user queries. Thus, a model may be trained to impart domain specific knowledge that can improve its performance in that anticipated context. Models trained according to this model training strategy can then be used by a scene understanding module to process validated user queries.

Several different types of model training can be implemented to improve query processing performance. Domain-specific dataset training, for example, involves training, e.g., object detectors and classifiers on datasets specific to the context of a monitored environment (e.g., public spaces, industrial settings) to enhance accuracy of object detection and classification for relevant objects. This is sometimes referred to as domain-specific model training. For example, training a model on video from public spaces or video that features industrial settings can enable that model to better process videos that feature public spaces or industrial settings.

Spatiotemporal datasets can also be used to train, e.g., VLLMs. Spatiotemporal datasets focus on sequences and object interactions over time. These datasets enable the model they train to better understand interactions and complex scenarios in real-time, facilitating high-level scene understanding essential for nuanced alert generation. A spatiotemporal dataset is a type of data that combines both spatial and temporal information to describe the location and movement of objects and events over time. It records the dynamic variations of spatial and thematic attributes throughout a specific timeframe. In essence, spatiotemporal datasets are crucial for analyzing how things change over both space and time, making them valuable for various applications such as epidemiology, environmental monitoring, surveillance, urban planning, etc.

Embedding models for object and scene association can also be implemented. An embedding model for a Vision Language Model (VLM) transforms both visual and textual inputs into a high-dimensional space where they can be compared and combined, allowing users to define objects and interactions dynamically through text. This is also known as vectorization. This embedding process enables the model to understand the connections between the two modalities and generate coherent and contextually relevant outputs.

For instance, in the context of scene understanding, a VLM can vectorize objects and images within key frames (or entire key frames), making it possible to conduct text-based searches for those objects. This can involve, for example, detecting objects, creating bounding boxes around them, and then cropping and resizing the images the objects appear in before vectorizing them using a VLM's image encoder. The embedding model helps in relating natural language queries with key frames and objects, facilitating efficient text-based searches or text-based Vision Large Language Model (VLLM) processing of scene content. Embedding models are useful for applications like image classification, finding the similarity between an image and a set of text descriptions, and generating contextualized descriptions of how multiple objects in a scene interact with one another.

Once the query parsing module has determined that reasoning is required, the reasoning engine takes over. The reasoning engine can then decide on a reasoning pathway for a validated user query based on query requirements. Queries can be subject to one or both of rule-based reasoning and VLLM reasoning. As shown in FIG. 6, the reasoning engine first checks whether rule-based reasoning is required and then it checks whether VLLM reasoning is required. Although these checks are shown schematically to occur in sequence, there is no reason why a VLLM reasoning check cannot occur before a rule-based reasoning check.

The rule-based reasoning check helps to determine query processing requirements. A rule-based reasoning check can look at objects in a scene (e.g., domain objects), attributes of those objects, movements and other metadata associated with those objects, at object characteristics including presence of domain objects, whether objects are stationary or moving, a count of objects, evaluates contextual complexity, and so on. To “look at objects in a scene,” the reasoning engine receives a frame document from the scene understanding module and uses information from the frame document to determine information about the scene.

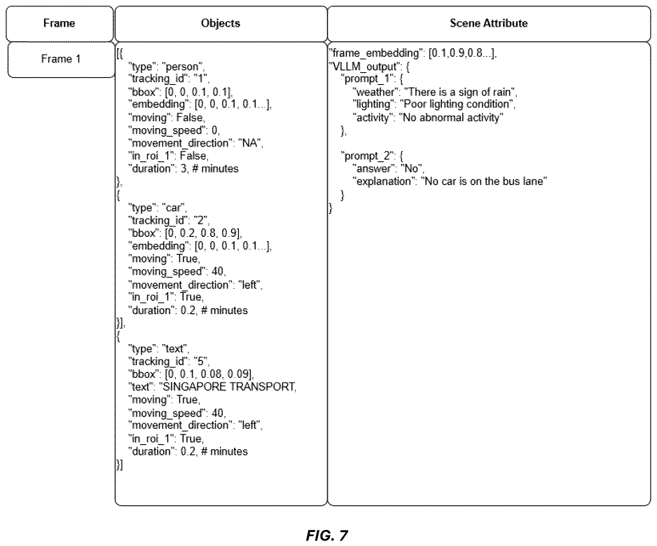

An example frame document is shown in FIG. 7. The frame document includes three objects: a person, a car, and text. Metadata associated with each of these objects is also included, such as a tracking ID, a bbox (e.g., a bounding box), an embedding (e.g., a vector representation), a movement indication, a movement speed, a movement direction, an indication as to whether the object appears in a region of interest, and a duration that the object appears (e.g., in a scene). Scene attributes are also included, such as a frame embedding (e.g., a vector representation of the frame) and VLLM outputs that result from pre-defined queries applied during Tier 3, as described above. For example, the first VLLM query can result in an output describing the weather (“there is a sign of rain”), the lighting (“poor lighting condition”), and activity (“no abnormal activity”). The answer to the second prompt is an answer to the question, “is a law against cars in the bus lane being violated?” The answer is “no,” and the explanation provided is “no car is in the bus lane.”

Based on the contents of the frame document and the validated user query, the reasoning engine can determine whether rule-based reasoning can be applied to the user query. In determining a type of reasoning required to evaluate a validated query, the reasoning module evaluates query complexity and identifies whether rule-based reasoning is sufficient to evaluate a query or if advanced reasoning (e.g., VLLM-based interpretation) is required.

Deciding whether rule-based reasoning, VLLM reasoning, or both will be required to process a user query can involve using basic information like object presence, location, movement, and so on. Rule-based reasoning can be efficient and suitable for, e.g., basic video monitoring. Rule-based reasoning can be appropriate when processing a query requires only information contained in a frame document (e.g., either using the information directly or using the information in the frame document to calculate other useful data, such as time durations). For example, if a query states, “generate an alert when car is seen with text ‘SIN TRANSPORT’ for more than 2 minutes,” all required information for the query would be present in a frame document, and thus rule-based reasoning is appropriate.

After establishing that rule-based reasoning is appropriate, the reasoning engine then checks whether VLLM reasoning is also appropriate. If a query cannot be resolved only using collected data in frame document, for example, VLLM reasoning is needed. VLLMs take image(s) and a text prompt as input and generate text as an answer. For example, if a query states, “set an alert for when a car is seen bearing the text ‘SIN TRANSPORT’ and a graffiti sticker.” Because the term “graffiti sticker” does not have corresponding metadata in the frame document, the system uses a VLLM to check whether there is a car with a “graffiti sticker.” In this example, both rule-based reasoning and VLLM reasoning are required.

VLLM reasoning can thus be needed in cases where a user's query asks for multiple alerts to be generated, and the different alerts have different reasoning requirements. For example, a query may ask, “show all scenes with a red suitcase and show all scenes where a firearm is placed in a red suitcase.” In that query, the first part relates only to attributes of an object (the object is a suitcase and the object is red) that are stored in a frame document, and the second part of that query asks to identify scenes that include an interaction that is not in a frame document, such as an interaction between multiple objects and a human.

A VLLM reasoning check can determine whether a query includes .object-object interactions, out of domain queries, and alert criteria that are not covered by rule-based reasoning. An “out of domain prompt” refers to a prompt or query that falls outside the specific domain or context for which a model or system has been trained or designed. In the context of machine learning and artificial intelligence, models are often trained on specific datasets that cover particular topics or domains. When a prompt or query is presented that doesn't align with these topics or domains, it is considered “out of domain.” For example, if a language model is trained primarily on medical texts and it receives a prompt about astrophysics, this would be an out of domain prompt. The model might struggle to provide accurate or relevant responses because it lacks sufficient training data in that area.

Object-object interactions are typically too complicated for rule-based reasoning to apply and cannot be resolved using information from a frame document alone. Object-object interactions can involve different movements, different speeds, collisions, objects changing shape after a collision, objects interacting with humans, and so on. Rule-based reasoning is suited for situations where, e.g., the presence of an object must be detected, or where an object is not subject to interaction with another object or with an environment. For example, whether a red suitcase is present in a scene, or whether a red suitcase is moving in a scene can be answered by rule-based reasoning. But when a query asks, “set an alert for when a yellow car drives through a tunnel,” the query asks for “a yellow car moving” and it asks, “is the yellow car driving through a tunnel?” Rule-based reasoning can determine whether a yellow car is moving and VLLM reasoning can answer whether that car is driving through a tunnel.

If rule-based reasoning is appropriate and no VLLM reasoning is required, then the reasoning engine can bypass VLLM reasoning and generate one or more alerts according to the user's query. Similarly, if rule-based reasoning is not required and VLLM reasoning is, then the reasoning engine can bypass the rule-based reasoning check. In most practical cases, it will be unusual for a query to not require at least rule-based reasoning, and, in general, at least rule-based reasoning will be required with VLLM reasoning being the type of reasoning that may or may not be needed.

An alert of the inventive subject matter can be an output comprising one or any combination of scenes, portions of scenes, key frames, or frames of scenes/videos that satisfy a user's query. Alerts can also include a summary of a detected event such as highlighted portions to draw attention to different objects, interactions, people, or the like. For example, if a user's query is “show me all the places where a red suitcase appears,” then the output could be an alert comprising several scenes where a red suitcase appears, and each time a red suitcase appears, the red suitcase could be bounded by an outlining box to draw attention to it. Outlining boxes that bound objects can be generated via, e.g., models that are included in sub-modules of Tier 1 of a scene understanding module of the inventive subject matter.

Alerts can include a summary of a detected event (e.g., based on a user query) and may contain relevant visual evidence, such as annotated snapshots, to provide context. This enhances situational awareness and aids in decision-making. Summaries can include one or both of text and visual information including annotated video and annotated key frames.

When an alert is generated according to a user's query, that alert can be communicated to the user in real or near-real-time based on operational needs, allowing prompt responses to critical events. This can be especially helpful in applications like, e.g., surveillance where prompt alert generation in real-time or near-real-time can be critically important. When an alert is generated, it can be made available to a user via network connection. For example, alerts can be generated via web portal or software as a service interface, they can be transmitted to a user's computing device to be visually displayed, and so on. Alerts can include audio content and visual content. For example, when an alert is generated, an alert packet comprising the alert can be transmitted to a user's device and cause the user's device to generate a notification. The notification can thus include audio (e.g., a sound, sound from a video, or the like) and/or visual content (e.g., video content, annotated video content, or the like).

As one example, in a situation where video is processed in real time, every time a red suitcase appears, the reasoning engine could generate an alert comprising a live stream that shows the red suitcase. The live stream alert can draw additional attention to the red suitcase via outlining, highlighting, color shifting, labeling, etc., all of which can be carried out by one or more sub-modules in Tier 1.

In cases where no rule-based reasoning is required, e.g., because the validated query is too complex in its entirety, then VLLM reasoning can be applied to the query. For example, if a prompt demands high-level interpretation, such as object interactions or nuanced behaviors, the reasoning engine can determine that VLLM reasoning is necessary. Thus, for complex, context-sensitive scenarios, a VLLM reasoning pathway is activated. This pathway provides nuanced understanding by integrating the basic object-level data from lower-tier models in the scene understanding module (e.g., Tier 1 models) with domain-specific VLLM insights. By using information from Tier 1 to “ground” the VLLM, the system avoids artificial intelligence “hallucination” (i.e., instances where an AI invents facts) and maintains reliability. It should be noted that in practice it would likely be unusual to invoke only VLLM reasoning without any rule-based reasoning, because most complex queries nevertheless often include more basic elements that can be handled via rule-based reasoning.

Alert generating embodiments of the inventive subject matter confer numerous advantages over existing technologies. For example, embodiments are capable of generating custom alerts from natural language user queries, which enhances system flexibility and adaptability, allowing for quick responses to new scenarios without technical help. Custom alerts can be tailored to specific needs, ensuring that users receive relevant information promptly. For instance, in a surveillance system, custom alerts could notify security professionals of specific activity types, which can be especially useful in certain places like airports and train stations. This not only improves user experience but also optimizes resource allocation across organizations.

Embodiments can also reduce system customization costs. Automatic prompt interpretation lessens a need for skilled developers, thereby reducing setup and maintenance expenses. This means that organizations can allocate their resources more efficiently and focus on other important aspects of their operations. Additionally, by simplifying the customization process, the system allows for quicker implementation and user adoption, leading to improved overall productivity and cost-effectiveness.

Embodiments also feature better context recognition that helps to reduce false alarms, making advanced models more reliable. By accurately understanding nuances of different situations, these models can significantly minimize errors in judgment or prediction. This improvement leads to increased trust and efficiency in systems relying on artificial intelligence, such as automated surveillance. Enhanced context recognition also allows models to perform well across a wider range of applications, ensuring consistent performance even in complex and dynamic environments.

Generalization capabilities of embodiments enable them to monitor multiple environments efficiently, making them suitable for various applications. These applications can range from environmental monitoring, where a system tracks changes in weather patterns or pollution levels, to industrial settings, where a system oversees production processes and ensures safety protocols, to security surveillance, where a system facilitates monitoring of sensitive areas such as airports. By leveraging these advanced generalization capabilities, systems of the inventive subject matter enhance operational efficiency and support informed decision-making.

The reasoning approach employed by embodiments of the inventive subject matter involves dynamically switching between rule-based and model-based reasoning (e.g., VLLM reasoning), which allows for balancing accuracy and computational efficiency, thereby adapting effectively to different monitoring scenarios. This hybrid approach ensures that systems can use strengths of both methods, leveraging the precision and clarity of rule-based reasoning when dealing with well-defined queries while taking advantage of the flexibility and learning capabilities of model-based reasoning in more complex queries. As a result, systems reliably perform across a wide range of applications, from real-time anomaly detection to long-term trend analysis, ultimately enhancing its robustness and versatility in addressing diverse monitoring needs.

Thus, specific systems and methods directed to the use of artificial intelligence to interpret video content in real time have been disclosed. It should be apparent, however, to those skilled in the art that many more modifications besides those already described are possible without departing from the inventive concepts in this application. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

What is claimed is:

1. An alert generating system, comprising:
a user interface configured to receive a user query about a scene;
a query module comprising a guardrail module and a query parsing module, wherein the query module is configured to receive the user query from the user interface and to use the query parsing module and the guardrail module to validate the user query to generate a validated user query;
a scene understanding module configured to process the scene to generate a frame document that comprises information about an object in the scene;
a reasoning engine configured to carry out a rule-based check and a VLLM reasoning check based on the validated user query and the frame document;
the reasoning engine configured to use at least one of rule-based reasoning and VLLM reasoning to generate an alert based on the validated user query and the frame document;
the reasoning engine further configured to transmit an alert packet to a computing device; and
wherein the alert packet causes the computing device to generate a visual notification of the alert.

2. The alert generating system of claim 1, wherein the query parsing module is configured to determine a set of models that are necessary to process the user query.

3. The alert generating system of claim 1, wherein the guardrail module is configured to filter prohibited user queries.

4. The alert generating system of claim 3, wherein the prohibited user queries are filtered based on a prohibited word or a prohibited context.

5. The alert generating system of claim 1, wherein the query parsing module is further configured to select a set of models for the scene understanding module to use to generate the frame document.

6. An alert generating system, comprising:
a user interface configured to receive a user query about a scene;
a query module comprising a query parsing module, wherein the query module is configured to receive the user query from the user interface and to use the query parsing module to validate the user query to generate a validated user query;
a scene understanding module configured to process the scene to generate a frame document that comprises information about an object in the scene;
a reasoning engine configured to carry out a rule-based check and a VLLM reasoning check based on the validated user query and the frame document;
the reasoning engine configured to use at least one of rule-based reasoning and VLLM reasoning to generate an alert based on the validated user query and the frame document;
the reasoning engine further configured to transmit an alert packet to a computing device; and
wherein the alert packet causes the computing device to generate a visual notification of the alert.

7. The alert generating system of claim 6, wherein the query module further comprises a guardrail module, and wherein the guardrail module is configured to filter prohibited user queries.

8. The alert generating system of claim 7, wherein the prohibited user queries are filtered based on a prohibited word or a prohibited context.

9. The alert generating system of claim 6, wherein the query parsing module is configured to determine a set of models that are necessary to process the user query.

10. The alert generating system of claim 6, wherein the query parsing module is further configured to select a set of models for the scene understanding module to use to generate the frame document.

11. An alert generating system, comprising:
a query module comprising a query parsing module, wherein the query module is configured to receive a user query and wherein the query parsing module is configured to determine a set of models that are required to process the user query;
a scene understanding module configured to process a scene using the set of models to generate a frame document that comprises contextual information about the scene;
a reasoning engine configured to carry out a rule-based check and a VLLM reasoning check based on the user query and the frame document;
the reasoning engine configured to use at least one of rule-based reasoning and VLLM reasoning to generate an alert based on the user query and the frame document;
the reasoning engine further configured to transmit an alert packet to a computing device; and
wherein the alert packet causes the computing device to generate a visual notification of the alert.

12. The alert generating system of claim 11, further comprising a guardrail module, and wherein the guardrail module is configured to filter prohibited user queries from being processed.

13. The alert generating system of claim 12, wherein the prohibited user queries are filtered based on at least one of a prohibited word and a prohibited context.

14. The alert generating system of claim 11, wherein the query parsing module is further configured to select a set of models for the scene understanding module to use to generate the frame document.
